(19) United States
(12) Patent Application Publication
(10) Pub. No.: US 2007/0226274 A1
(43) Pub. Date: Sep. 27, 2007

(54) Database device, and computer product

(75) Inventor: Mitsuhide Nishino, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED

(21) Appl. No.: 11/451,040

(22) Filed: Jun. 12, 2006

(30) Foreign Application Priority Data
Mar. 27, 2006 (JP) 2006-086343

(51) Int. Cl. G06F 17/30

(52) U.S. Cl. 707/204

(57) ABSTRACT

When generating initial data for carrying out replication of a table for replication, a replication data generating function establishes a correspondence between content of each row of the table and a physical row number, and outputs the physical row number of each row. A replication data reflecting function includes the physical row number from a replication source in a portion of the row and fetches the initial data. Fetching the initial data enables to establish a correspondence of rows in the replication source and the replication destination even if the table does not include a unique key.

### BACKGROUND OF THE INVENTION

1. Field of the Invention

The present invention generally relates to a technology for generating replication of a table, and specifically relates to a technology for generating replication of a table in another database even if the table does not include a unique key.

2. Description of the Related Art

A technology that generates replication of a database, called replication technology, is used as one of the effective measures for realizing load sharing of the database (for example, Japanese Patent Laid-Open Publication No 2002-132563). According to the replication technology, a reference database having the same content as the content of a database for updation is included separately, and updation content of the database for updation is reflected periodically or in real time in the reference database.

However, in the conventional replication technology including the technology disclosed in Japanese Patent Laid-Open Publication No 2002-132563, a correspondence is established between replication source data and replication destination data, thereby necessitating inclusion of a unique key such as a primary key etc. in a table that is subjected to replication. Due to this, when a table that is operated without the unique key needs to be replicated in another database, a new unique key must be added to the table. When adding the new unique key, process logic of the related service applications must be modified.

Modifying the process logic of the service applications not only requires a large number of person hours during testing, but can also result in significant amount of loss due to occurrence of test leakage during operation.

Thus, there is a need for a technology that enables generation of replication of the table even when the table does not include a unique key.

### SUMMARY OF THE INVENTION

It is an object of the present invention to at least partially solve the problems in the conventional technology.

According to an aspect of the present invention, a computer-readable recording medium that stores therein a computer program that generates data for replicating a first table in a first database to a second table in a second database, causes the computer to execute generating initial data that includes a correspondence of content of each row of the first table and a physical row number of the row; and generating differential data, when contents of a row in the first table have been updated, that includes a correspondence of changes in the row and a physical row number of updated row.

According to another aspect of the present invention, a computer-readable recording medium that stores therein a computer program that for reflecting data for replicating a first table in a first database to a second table in a second database, causes the computer to execute generating, when the data being initial data for newly generating the second table, the second table by including an additional column in to columns of the first table included in the first database, for setting a physical row number of each row in the table, and sets in the column of a row wherein the data is added, the physical row number that is recorded in the data and corresponds to data that indicates a content of the row; and reflecting, when the data being differential data for updating the second table, by checking with the additional column, the physical row number that is recorded in the data and corresponds to data that indicates updation content, and identifying the row that is subjected to updation.

According to still another aspect of the present invention, a database device that replicates a first table included in the database device as a second table in another database device, includes an initial data generating unit that generates initial data that includes a correspondence of content of each row of the first table and a physical row number of the row; and a differential data generating unit that generates differential data, when contents of a row in the first table have been updated, that includes a correspondence of changes in the row and a physical row number of updated row.

According to still another, aspect of the present invention database device that replicates a second table in the database device by fetching predetermined data relating to a first table included in another database device, includes an initial data reflecting unit that generates, when the data being initial data for newly generating the second table, the second table by including an additional column in to columns of the first table included in the first database, for setting a physical row number of each row in the table, and sets in the column of a row wherein the data is added, the physical row number that is recorded in the data and corresponds to data that indicates a content of the row; and a differential data reflecting unit that carries out an updation process, when the data being differential data for updating the second table, by checking with the additional column, the physical row number that is recorded in the data and corresponds to data that indicates updation content, and identifying the row that is subjected to updation.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic for explaining an outline of a database replication method according to an embodiment of the present invention;

FIG. 2 is a schematic for explaining an operation for reflecting in a replication destination a modification of a row in a replication source;

FIG. 3 is a schematic for explaining an operation for reflecting in the replication destination, a deletion of a row in the replication source;

FIG. 4 is a schematic for explaining an operation for reflecting in the replication destination, an addition of a row in the replication source;

FIG. 5 is a schematic for explaining an operation to carry out realignment of a replication source table;

FIG. 6 is a schematic for explaining an operation for reflecting in the replication destination, a modification of rows in the replication source after executing realignment on the replication source table;

FIG. 7 is a schematic for explaining an operation for reflecting in the replication destination, a deletion of a row in the replication source after executing realignment on the replication source table;

FIG. 8 is a schematic for explaining an operation for reflecting in the replication destination, an addition of a row in the replication source after executing realignment on the replication source table;

FIG. 9 is a functional schematic for explaining a replication source database device according to the embodiment;

FIG. 10 is a functional schematic for explaining a replication destination database device according to the embodiment;

FIG. 11 is a flowchart of a process performed by a replication data generating unit shown in FIG. 9;

FIG. 12 is a flowchart of a process performed by a replication data reflecting unit shown in FIG. 9; and

FIG. 13 is a functional schematic for explaining a computer that implements the method or the steps according to the embodiment.

### DETAILED DESCRIPTION OF THE PREFERRED EMBODIMENTS

Exemplary embodiments of the present invention are explained in detail next with reference to the accompanying drawings. The invention is by no means limited to the embodiments.

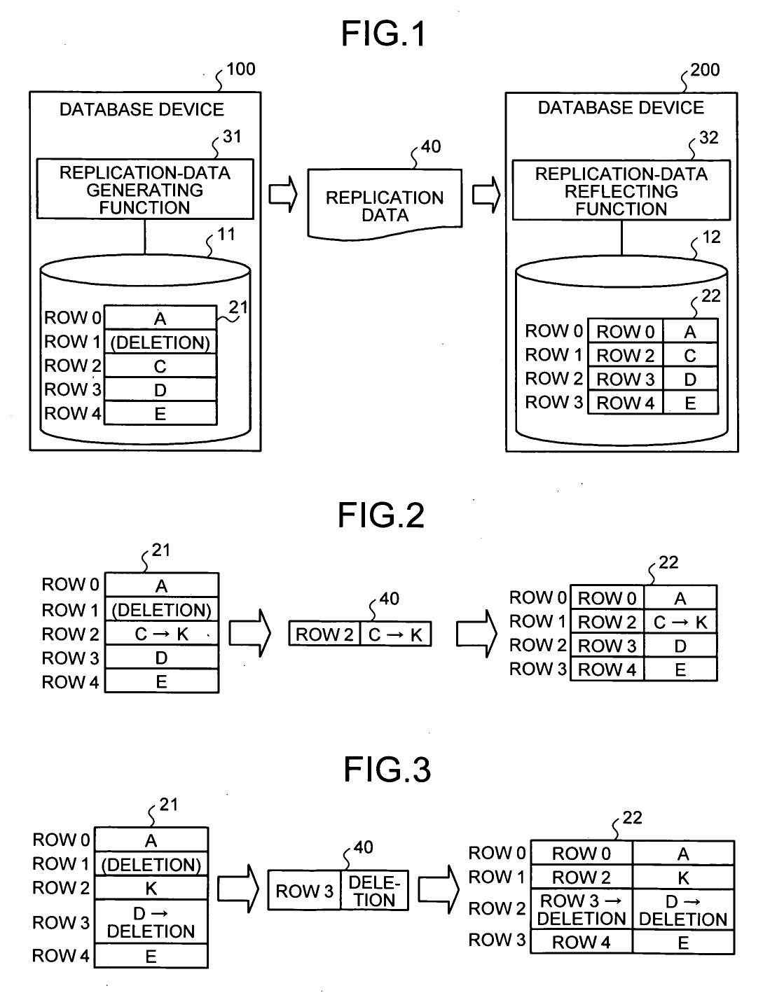

An outline of a database replication method according to an embodiment of the present invention is explained first. FIG. 1 is a schematic for explaining the outline of the database replication method according to the embodiment.

The example shown in FIG. 1 assumes a case in which a table 21 that is stored in a database 11 of a database device 100 is replicated to generate a table 22 in a database 12 of another database device 200, and that the table 21 does not include a unique key.

Replication of the table 21 is realized by sending replication data 40 from a replication data generating function 31 included in the database device 100 to a replication data reflecting function 32 included in the database device 200. However, the present invention is not limited to a method that carries out distribution of the replication data 40.

Specifically, the replication data generating function 31 generates, as the replication data 40, initial data for generating replication of the table 21, and sends the generated replication data 40 to the replication data reflecting function 32. The replication data reflecting function 32 receives the replication data 40 and generates the table 22 based on the replication data 40.

When generating the replication data 40, for enabling to establish a correspondence between rows of the table 21 and the table 22, the replication data generating function 31 adds a physical row number of each row in the content of the respective row of the table 21 in the replication data 40.

The physical row number is also called Program Current Status (PGCS) or Row Identification (ROWID) and indicates a physical position of the row. The physical row number is used in internal processes of the database device 100 and the database device 200, is included in the table 21 and the table 22, and is guaranteed to be unique in both the table 21 and the table 22.

Upon receiving the replication data 40, the replication data reflecting function 32 includes the added physical row number in a portion of the row and generates the table 22. To be specific, the replication data reflecting function 32 adds a column for storing the physical row number in the table 22 and sets in the added column the physical row number that is added in each row.

Thus, in the database replication method, the physical row number is added to the content of each row in a replication source table to generate the initial data for replication, and the physical row number is included in a portion of the rows in a replication destination table, thereby enabling to establish a correspondence between the rows of the replication source table and the rows of the replication destination table.

In the example shown in FIG. 1, a row having a value “C” is stored at a position indicated by a physical row number ROW 2 in the table 21, and is stored at a position indicated by a physical row number ROW 1 in the table 22. Thus, the same data does not necessarily include the same physical row number in the replication source table and the replication destination table. However, the physical row number ROW 2 from the replication source table is set to the row having the value “C” in the added column of the table 22, thereby enabling to use the physical row number and establish a correspondence between the rows.

Thus, after completion of generation and fetching of the initial data for replication, the replication data generating function 31 generates in the form of the replication data 40 differential data for reflecting updation content that is carried out on the table 21. Next, the replication data reflecting function 32 fetches the replication data 40 and update the table 22 based on the replication data 40.

An operation for reflecting in the replication destination table 22 the updation content that is carried out on the replication source table 21 is explained in detail with reference to FIG. 2 to FIG. 8.

FIG. 2 is a schematic for explaining an operation for reflecting in the replication destination a modification of a row in the replication source. Upon modifying the row having the value “C” in the replication source table 21 such that the same row has a value “K”, the operation for reflecting the updation content in the replication destination table 22 is shown in FIG. 2.

The replication data generating function 31 establishes a correspondence between the physical row number ROW 2 of the row that is subjected to modification of value and data that indicates that the value “C” is modified to the value “K”, and outputs the correspondence to the replication data 40. Upon fetching the replication data 40, the replication data reflecting function 32 in the table 22 modifies from “C” to “K”, the value of the row having the value ROW 2 in the column that indicates the physical row number from the replication source table.

Thus, the physical row number of the row that is subjected to modification in the replication source table is included in the differential data along with modification content, and based on the physical row number, the row for modification in the replication destination table is specified, thereby enabling to accurately reflect in the replication destination, the modification of the row in the replication source.

FIG. 3 is a schematic for explaining an operation for reflecting in the replication destination, a deletion of a row in the replication source. Upon deleting the row having the value “D” in the replication source table 21, the operation for reflecting the updation content in the replication destination table 22 is shown in FIG. 3.

The replication data generating function 31 establishes a correspondence between the physical row number ROW 3 of the row that is deleted and data that indicates that the row is deleted, and outputs the correspondence to the replication data 40. Upon fetching the replication data 40, the replication data reflecting function 32 in the table 22 deletes the row having the value ROW 3 in the column that indicates the physical row number from the replication source.

Thus, the physical row number of the row that is deleted in the replication source table is included in the differential data along with data that indicates deletion, and based on the physical row number, the row for deletion in the replication destination table is specified, thereby enabling to accurately reflect in the replication destination, the deletion of the row in the replication source.

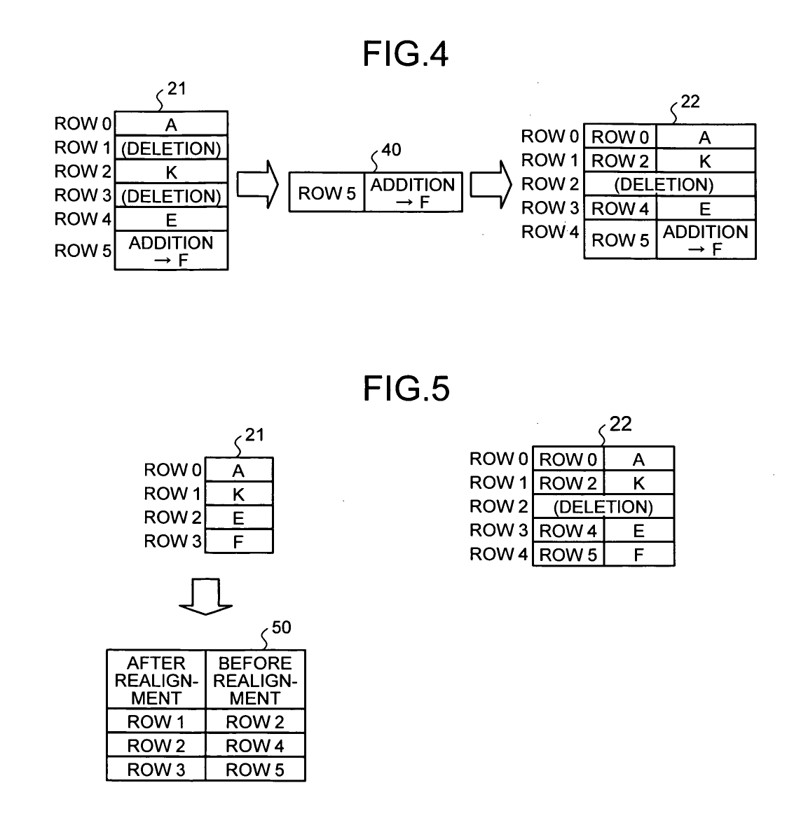

FIG. 4 is a schematic for explaining an operation for reflecting in the replication destination, an addition of a row in the replication source. Upon adding the row having the value “F” in the replication source table 21, the operation for reflecting the updation content in the replication destination table 22 is shown in FIG. 4.

The replication data generating function 31 establishes a correspondence between the physical row number ROW 5 of the row that is added and data that indicates that the row having the value “F” is added, and outputs the correspondence to the replication data 40. Upon fetching the replication data 40, the replication data reflecting function 32 in the table 22 adds the row having the value “F” and sets ROW 5 as the value in the column that indicates the physical row number from the replication source.

Thus, the physical row number of the row that is added in the replication source table is included in the differential data along with addition content, and an addition process is carried out in the replication destination table by including the physical row number from the replication source in a portion of the row. Thus, if the row in the replication source table is modified or deleted, the updation content can be accurately reflected in the replication destination.

A process called realignment is carried out in the database device for enhancing the speed of an input output process.

For example, in the table 21 shown in FIG. 4, a row indicated by the physical row number ROW 1 and a row indicated by the physical row number ROW 3 are unused due to deletion. Repeatedly carrying out addition or deletion of rows in the table results in formation of unused portions in the area of table.

If a large number of unused portions are formed in the table, when executing sequential reading of all the rows of the table, reading is carried out including the unused portions, thereby increasing the frequency of reading operation and resulting in a longer processing time.

A realignment process carries out importing and exporting of tables to eliminate the unused portions in the area of the tables, thereby enhancing input output performance. However, upon executing realignment, a physical position of each row in the table is modified, thereby changing the physical row number.

Thus, executing realignment on the table that has established a correspondence with the rows of the replication destination using the physical row numbers results in disabling of the established correspondence of the rows. To overcome the aforementioned drawback, in the database replication method according to the present embodiment, when executing realignment on the replication source table, a conversion table is generated that records a correspondence between the physical row numbers before and after realignment, and using the conversion table, a correspondence is established between the rows of the replication source table and the rows of the replication destination table.

FIG. 5 is a schematic for explaining an operation to carry out realignment of a table in the replication source. The operation to execute realignment on the table 21 shown in FIG. 4 is shown in FIG. 5.

Due to realignment, a row in the position indicated by the physical row number “ROW0” remains in the position indicated by the physical row number “ROW0” as before. Rows in the positions indicated by the physical row numbers ROW 2, ROW 4, and ROW 5 are moved to the positions indicated by the physical row numbers ROW 1, ROW 2, and ROW 3 respectively.

The replication data generating function 31 outputs to a conversion table 50, the physical row numbers before and after realignment of the rows that are subjected to modification of the physical row number due to realignment. In the example shown in FIG. 5, three data, in other words, data of the physical row number ROW 1 after modification and the physical row number ROW 2 before modification, data of the physical row number ROW 2 after modification and the physical row number ROW 4 before modification, and data of the physical row number ROW 3 after modification and the physical row number ROW 5 before modification are output to the conversion table 50.

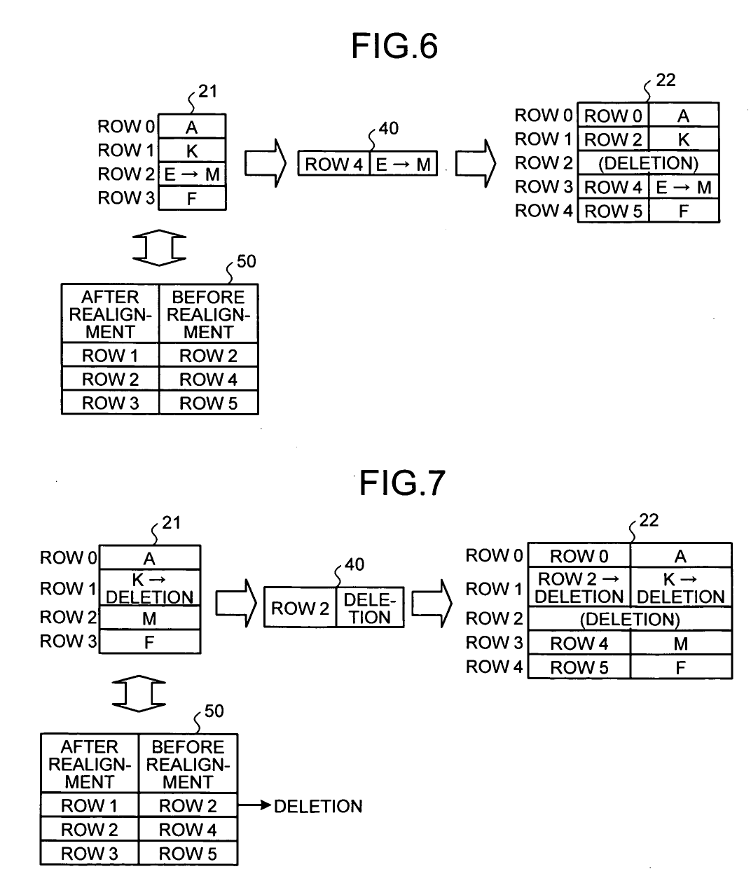

FIG. 6 is a schematic for explaining an operation for reflecting in the replication destination, modification of rows in the replication source after executing realignment on the replication source table. Due to modification of a row having the value “E” in the replication source table 21 to the same row having the value “M”, the operation for reflecting the updation content in the table 22 is shown in FIG. 6.

The replication data generating function 31 confirms whether the conversion table 50 includes data that maintains as the physical row number after realignment, ROW 2 that is the physical row number of the row subjected to modification of value. If the conversion table 50 does not include the aforementioned data, similarly as shown in FIG. 2, the replication data generating function 31 establishes a correspondence between the physical row number ROW 2 of the row subjected to modification of value and modification content, and outputs the correspondence to the replication data 40.

In the example shown in FIG. 6, because the conversion table 50 includes the data of the physical row number ROW 2 after realignment and the physical row number ROW 4 before realignment, the replication data generating function 31 establishes a correspondence between the physical row number ROW 4 before realignment of the row that is subjected to modification and data that indicates that the value “E” is changed to the value “M”, and outputs the correspondence to the replication data 40. Upon fetching the replication data 40, the replication data reflecting function 32 in the table 22 modifies from “E” to “M”, the value of the row having the value ROW 4 in the column that indicates the physical row number from the replication source.

Thus, the physical row number of the row that is modified in the replication source table is converted to the physical row number before realignment by referring to the conversion table, the physical row number is included in the differential data along with the modification content, and based on the physical row number, the row for modification in the replication destination table is specified, thereby enabling to accurately reflect in the replication destination, the modification of the row in the replication source even after executing realignment in the replication source.

FIG. 7 is a schematic for explaining an operation for reflecting in the replication destination, a deletion of a row in the replication source after executing realignment on the replication source table. Upon deleting the row having the value “K” in the replication source table 21, the operation for reflecting the updation content in the replication destination table 22 is shown in FIG. 7.

The replication data generating function 31 confirms whether the conversion table 50 includes data that maintains as the physical row number after realignment, the physical row number ROW 1 of the row subjected to deletion. If the conversion table 50 does not include the aforementioned data, similarly as shown in FIG. 3, the replication data generating function 31 establishes a correspondence between the physical row number ROW 1 of the row subjected to deletion and the data that indicates that the row is deleted, and outputs the correspondence to the replication data 40.

In the example shown in FIG. 7, because the conversion table 50 includes the data of the physical row number ROW 1 after realignment and the physical row number ROW 2 before realignment, the replication data generating function 31 establishes a correspondence between the physical row number ROW 2 before realignment of the row that is subjected to deletion and the data that indicates that the row is deleted, and outputs the correspondence to the replication data 40. Upon fetching the replication data 40, the replication data reflecting function 32 in the table 22 deletes the row having the value ROW 2 in the column that indicates the physical row number from the replication source.

Because the row having the physical row number ROW 1 in the replication source is deleted from both the replication source and the replication destination, thereby removing the need to establish the correspondence of rows, the replication data generating function 31 deletes from the conversion table 50 the data of the physical row number ROW 1 after realignment.

Thus, the physical row number of the row that is deleted in the replication source table is converted to the physical row number before realignment by referring to the conversion table, the physical row number is included in the differential data along with the data that indicates that the row is deleted, and based on the physical row number, the row for deletion in the replication destination table is specified, thereby enabling to accurately reflect in the replication destination, the deletion of the row in the replication source even after executing realignment in the replication source.

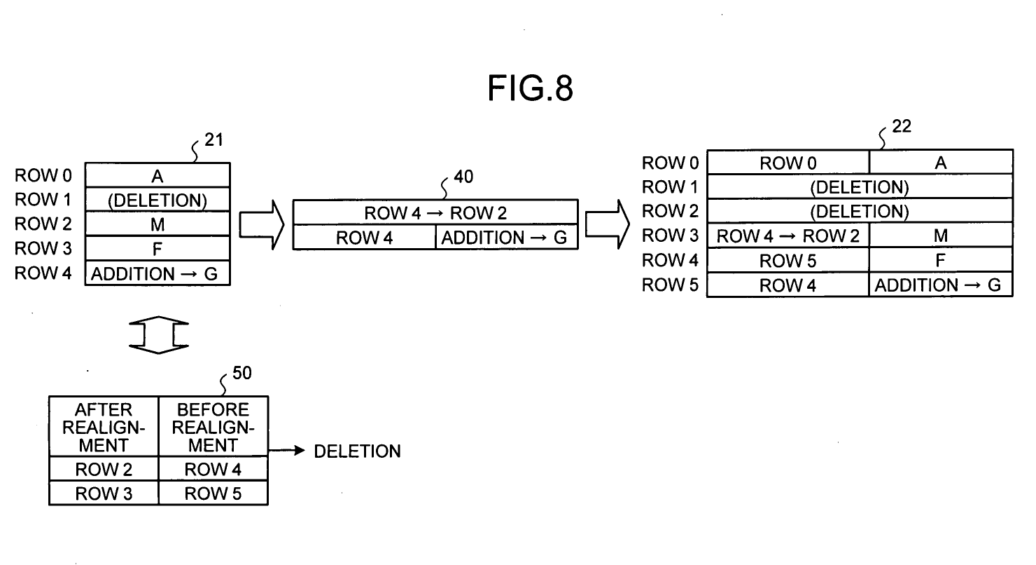

FIG. 8 is a schematic for explaining an operation for reflecting in the replication destination, an addition of a row in the replication source after executing realignment on the replication source table. Upon adding the row having the value “G” in the replication source table 21, the operation for reflecting the updation content in the replication destination table 22 is shown in FIG. 8.

In the replication source table 21, a row having the value “G” is added at a position indicated by the physical row number ROW 4. The conversion table 50 includes data of the physical row number ROW 4 before realignment.

Thus, the replication destination table 22 includes the row having the physical row number ROW 4 set in the column that indicates the physical row number from the replication source. Reflecting the addition of the row in the table 22 in such a condition results in formation of two rows having the value ROW 4 in the column that indicates the physical row number from the replication source, thereby disrupting the correspondence of the rows.

To avoid such a disruption, the replication data generating function 31 carries out steps for enabling to establish a correspondence in the table 22 between the row having the value ROW 4 in the column that indicates the physical row number from the replication source and the row in the table 21 without referring to the conversion table 50.

To be specific, upon referring to the conversion table 50, because the row having the physical row number ROW 4 before realignment in the table 21 is allocated the physical row number ROW 2 after realignment, the replication data generating function 31 outputs to the replication data 40, data for modifying in the table 22, the physical row number from ROW 4 to ROW 2 in the column that indicates the physical row number before realignment.

Next, the replication data generating function 31 deletes unnecessary data of the conversion table 50. In other words, the replication data generating function 31 deletes data of the physical row number ROW 4 before realignment. After carrying out the steps for preventing disruption of the correspondence of rows, the replication data generating function 31 establishes a correspondence between the physical row number ROW 4 of the row that is added and data that indicates addition of the row having the value “G”, and outputs the correspondence to the replication data 40.

Upon fetching the replication data 40, the replication data reflecting function 32 in the table 22 modifies from ROW 4 to ROW 2 the value that is set in the column that indicates the physical row number from the replication source. Next, the replication data reflecting function 32 adds the row having the value “G” and sets ROW 4 as the value of the added row in the column that indicates the physical row number from the replication source.

Before outputting data for reflecting the row that is added in the replication source table to the differential data, steps are carried out to prevent disruption of the correspondence of rows, thereby enabling to accurately reflect in the replication destination, the addition of the row in the replication source even after executing realignment in the replication source.

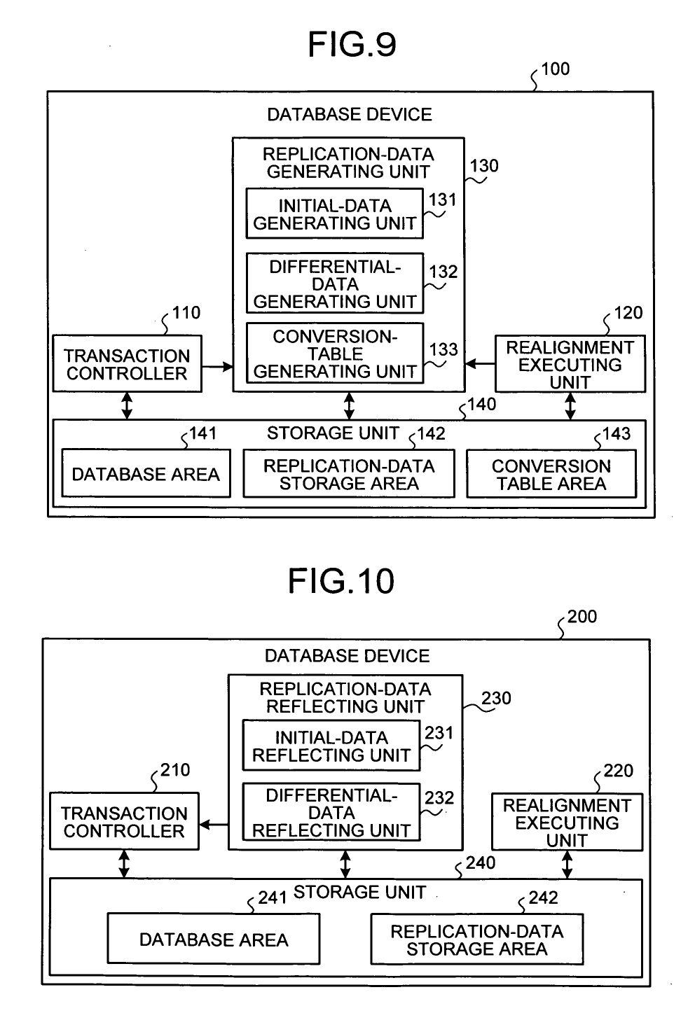

The structures of the database device 100 and the database device 200 that are shown in FIG. 1 are explained next. FIG. 9 is a functional block diagram of the replication source database device 100. The database device 100 includes a transaction controller 110, a realignment executing unit 120, a replication data generating unit 130, and a storage unit 140. The transaction controller 110 controls an updation process of various tables, and the realignment executing unit 120 executes realignment.

The replication data generating unit 130 realizes the replication data generating function 31 that is shown in FIG. 1. The replication data generating unit 130 includes an initial data generating unit 131, a differential data generating unit 132, and a conversion table generating unit 133.

The initial data generating unit 131 generates the replication data 40 as initial data for generating replication of a table. The initial data generating unit 131 outputs data, which includes a physical row number that is added to each row of the table that is subjected to replication.

The differential data generating unit 132 generates the replication data 40 as differential data for reflecting in the replication destination a result of the updation process that is executed by the transaction controller 110. A process to generate the differential data is explained in detail later.

When the realignment executing unit 120 executes a realignment process on the table that is subjected to replication, the conversion table generating unit 133 generates, simultaneously with the realignment executing unit 120, the conversion table 50 that corresponds to the table subjected to replication.

The storage unit 140 stores various data and includes a database area 141, a replication data storage area 142, and a conversion table area 143. The database area 141 stores various tables and an index of the tables.

The replication data storage area 142 stores the replication data 40 that is generated by the initial data generating unit 131 and the differential data generating unit 132. The conversion table area 143 stores the conversion table 50 that is generated by the conversion table generating unit 133.

FIG. 10 is a functional block diagram of the structure of the replication destination database device 200. The database device 200 includes a transaction controller 210, a realignment executing unit 220, a replication data reflecting unit 230, and a storage unit 240. The transaction controller 210 and the realignment executing unit 220 are similar to the transaction controller 110 and the realignment executing unit 120 respectively.

The replication data reflecting unit 230 realizes the replication data reflecting function 32 that is shown in FIG. 1. The replication data reflecting unit 230 includes an initial data reflecting unit 231, and a differential data reflecting unit 232.

The initial data reflecting unit 231 reads the replication data 40 that is generated as the initial data and generates a table. When generating the table, the initial data reflecting unit 231 adds a column for storing the physical row numbers from the replication source, and stores in the column, the physical row numbers that correspond to data of each row and that are recorded in the replication data 40.

The differential data reflecting unit 232 reads the replication data 40 that is generated as the differential data and updates the table. Based on the physical row numbers from the replication source that are stored in the column that is added to the table by the initial data reflecting unit 231, the differential data reflecting unit 232 specifies the rows for updation.

The storage unit 240 stores various types of data and includes a database area 241, and a replication data storage area 242. The database area 241 stores various tables and an index of the tables. The replication data storage area 242 stores the replication data 40 that is fetched from the database device 100.

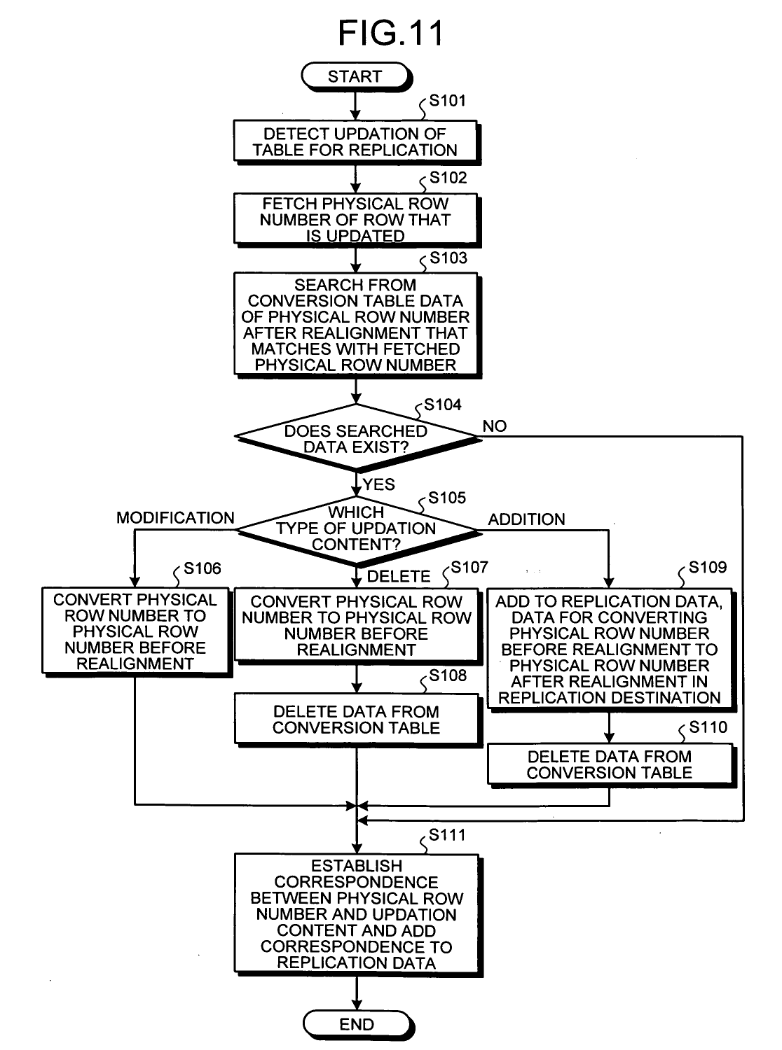

A sequence of a process of the replication data generating unit 130 shown in FIG. 9 and a sequence of a process of the replication data reflecting unit 230 shown in FIG. 10 are explained next. FIG. 11 is a flowchart of the sequence of the process performed by the replication data generating unit 130. A sequence of a process to generate the differential data is also shown in FIG. 11.

As shown in FIG. 11, upon detecting updation of the table for replication (step S101), the differential data generating unit 132 fetches the physical row number of the row that is updated (step S102). Next, the differential data generating unit 132 refers to the conversion table 50 that corresponds to the table, and searches data of the physical row number after realignment that matches with the physical row number fetched at step S102 (step S103).

If the conversion table 50 corresponding to the table for replication is not generated or does not include the searched data (“No” at step S104), the differential data generating unit 132 establishes a correspondence between the physical row number fetched at step S102 and the updation content, and adds the correspondence to the replication data 40, thereby ending the process (step S111).

If the conversion table 50 includes the searched data (“Yes” at step S104), the differential data generating unit 132 modifies the process depending on whether the detected updation content is a modification of content of the row, a deletion of the row, or an addition of the row.

If the detected updation content is the modification of content of the row (“Modification” at step S105), the differential data generating unit 132 modifies the physical row number before realignment that is included in the data fetched from the conversion table 50 at step S103 to the physical row number of the row that is modified (step S106). Next, the differential data generating unit 132 establishes a correspondence between the physical row number and the updation content, and adds the correspondence to the replication data 40, thereby ending the process (step S111).

If the detected updation content is the deletion of the row (“Deletion” at step S105), the differential data generating unit 132 modifies the physical row number before realignment that is included in the data fetched from the conversion table 50 at step S103 to the physical row number of the row that is deleted (step S107), and deletes the row from the conversion table 50 (step S108). Next, the differential data generating unit 132 establishes a correspondence between the physical row number and the updation content, and adds the correspondence to the replication data 40, thereby ending the process (step S111).

If the detected updation content is the addition of the row (“Addition” at step S105), the differential data generating unit 132 adds to the replication data 40, data for modifying, from the physical row number before realignment in the data fetched from the conversion table 50 at step S103 to the physical row number after realignment, the value that is maintained in the replication destination table as the physical row number from the replication source (step S109). Next, the differential data generating unit 132 deletes the row from the conversion table 50 (step S110), establishes a correspondence between the physical row number of the added row and the updation content, and adds the correspondence to the replication data 40, thereby ending the process (step S111).

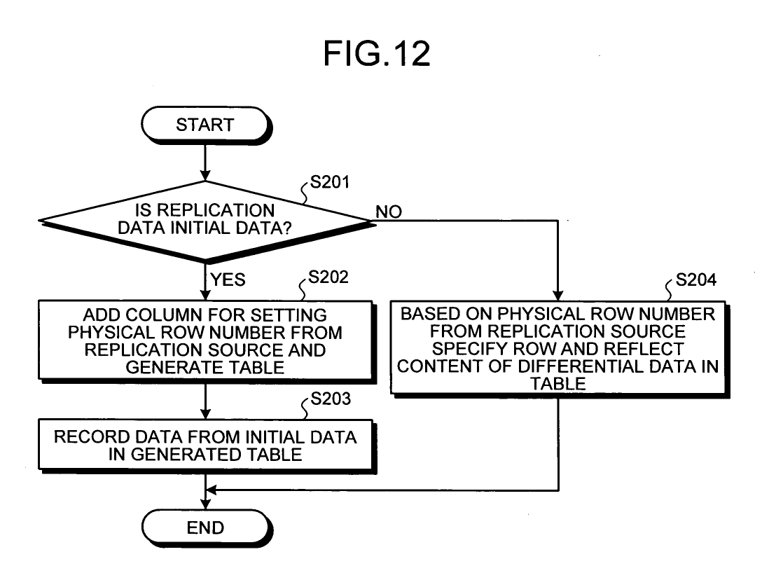

FIG. 12 is a flowchart of the sequence of the process of the replication data reflecting unit 230. A sequence of a process to reflect the replication data 40 that is fetched from the replication source is also shown in FIG. 12.

As shown in FIG. 12, if the replication data 40 is the initial data (“Yes” at step S201), the initial data reflecting unit 231 adds the column for setting the physical row number from the replication source to generate the table (step S202), and records data from the initial data in the generated table (step S203).

If the replication data 40 is the differential data (“No” at step S201), based on the physical row number from the replication source included in the differential data, the differential data reflecting unit 232 specifies the row, and reflects the content of the differential data in the table (step S204).

Functions of the replication data generating unit 130 and the replication data reflecting unit 230 explained in the embodiment can also be realized by causing a computer to execute a prior formulated replication data generating program and a replication data reflecting program. An example of the computer that executes the replication data generating program and the replication data reflecting program is explained next.

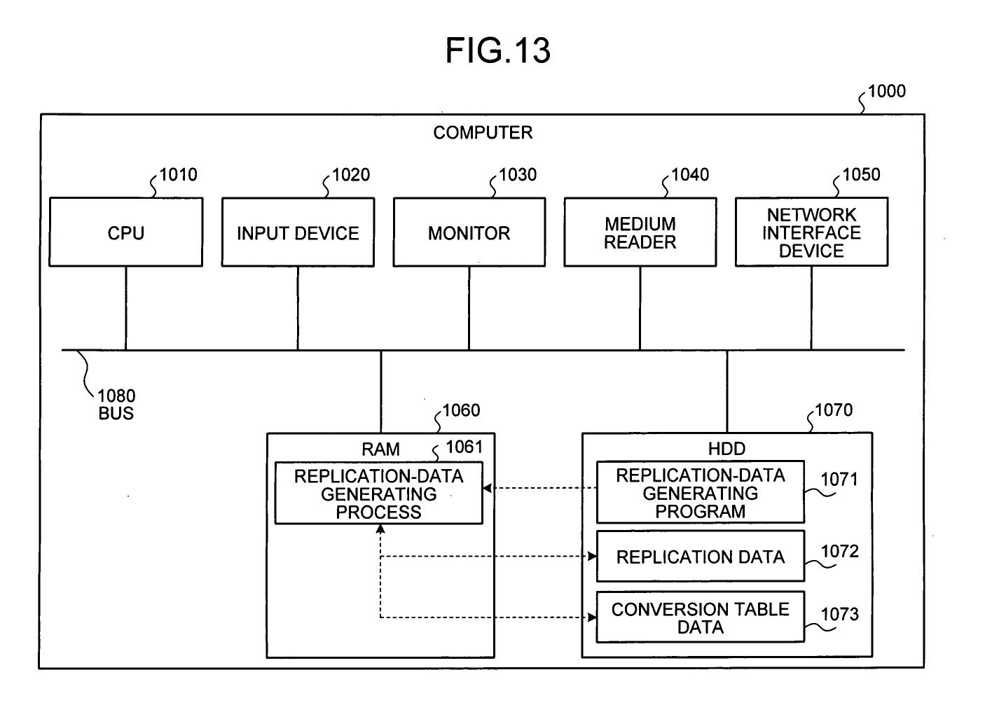

FIG. 13 is a functional block diagram of a computer 1000 that implements the methods or steps or processes completely or partly by executing a replication data generating program 1071. The computer 1000 includes a central processing unit (CPU) 1010 that executes various computation processes, an input device 1020 that receives an input of data from a user, a monitor 1030 that displays various types of data, a medium reader 1040 that reads a program from a recording medium that records various types of programs, a network interface device 1050 that carries out transfer of data between the computer 1000 and other computers via a network, a random access memory (RAM) 1060 that temporarily stores various types of data, and a hard disk device (HDD) 1070 that are connected by buses 1080.

The HDD 1070 stores the replication data generating program 1071 that includes functions similar to the replication data generating unit 130 shown in FIG. 9, replication data 1072 that corresponds to the replication data 40, and conversion table data 1073 that corresponds to the conversion table 50.

The CPU 1010 reads the replication data generating program 1071 from the HDD 1070 and expands the replication data generating program 1071 to the RAM 1060, thereby causing the replication data generating program 1071 to function as a replication data generating process 1061.

The replication data generating process 1061 monitors updation of a table for replication in a database system operating in another computer that is connected to the computer 1000 or a network. Upon detecting updation, the replication data generating process 1061 expands data read from the conversion table data 1073 to the area allocated to the replication data generating process 1061 on the RAM 1060. Based on the expanded data, the replication data generating process 1061 executes various types of data processes, and records the differential data in the replication data 1072.

The replication data generating program 1071 need not always be stored in the HDD 1070. The replication data generating program 1071 stored in a storage medium such as a compact disk read-only memory (CD-ROM) can be read by the computer 1000 and executed. The replication data generating program 1071 can also be stored in another computer (or a server) that is connected to the computer 1000 via a public line, the Internet, a local area network (LAN), a wide area network (WAN) etc., read by the computer 1000 from the other computer (or the server) and executed.

The replication data reflecting program can be similarly stored in the HDD 1070, read by the computer 1000 or the other computer, and executed, thereby enabling to realize the functions of the replication data reflecting unit 230 shown in FIG. 10.

In the present embodiment, a physical row number, which exists in any table and is unique in the table, is added to the initial data and the differential data that are transmitted to a replication destination database, thereby enabling to accurately reflect in the replication destination database, updation carried out in a replication source database even if a table without a unique key is replicated.

When executing realignment on the replication source table, a conversion table is generated that records a correspondence between the physical row number before realignment and the physical row number after realignment, and when generating the differential data, the conversion table is used to convert the physical row number of the updated row to the physical row number before realignment. Thus, updation carried out in the replication source database can be accurately reflected in the replication destination database even if the physical row number of each row in the replication source table is modified due to realignment.

The database replication method according to the present embodiment can be combined with the conventional database replication method. In other words, the database replication method according to the present embodiment can be used when replicating a table that does not include a unique key, and the conventional database replication method can be used when replicating a table that includes a unique key.

According to an embodiment of the present invention, a physical row number, which exists in any table and is unique in the table, is added to initial data and differential data that are transmitted to a replication destination database, thereby enabling to accurately reflect in the replication destination database, updation carried out in a replication source database even if a table without a unique key is replicated.

According to another embodiment of the present invention, when executing realignment on the replication source table, a conversion table is generated that records a correspondence between the physical row number before realignment and the physical row number after realignment, and when generating the differential data, the conversion table is used to convert the physical row number of the updated row to the physical row number before realignment. Thus, updation carried out in the replication source database can be accurately reflected in the replication destination database even if the physical row number of each row in a replication source table is modified due to realignment.

According to another embodiment of the present invention, the physical row number that is recorded in the initial data and corresponds to data of each row of the table subjected to replication is included in a portion of the row to generate the replication destination table, and the physical row number is checked with the physical row number that is recorded in the differential data and corresponds to updation content to specify the row that reflects the updation content, thereby enabling to accurately reflect in the replication destination database, updation carried out in the replication source database even if a table without a unique key is replicated.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A computer-readable recording medium that stores therein a computer program that generates data for replicating a first table in a first database to a second table in a second database, the computer program causing the computer to execute:
generating initial data that includes a correspondence of content of each row of the first table and a physical row number of the row; and
generating differential data, when contents of a row in the first table have been updated, that includes a correspondence of changes in the row and a physical row number of updated row.

2. The computer-readable recording medium according to claim 1, wherein the generating differential data includes generating differential data, when contents of a row in the first table have been changed, that includes a correspondence of changes in the row and a physical row number of changed row.

3. The computer-readable recording medium according to claim 1, wherein the generating differential data includes generating differential data, when a row in the first table has been deleted, that includes a correspondence of information indicative that the row has been deleted and a physical row number of deleted row.

4. The computer-readable recording medium according to claim 1, wherein the generating differential data includes generating differential data, when a row in the first table has been added, that includes a correspondence of information indicative that the row has been added and a physical row number of added row.

5. The computer-readable recording medium according to claim 1, further causing the computer to execute a generating a conversion data, when a physical row number of each row of the first table is modified due to realignment, that includes a correspondence of a physical row number before realignment and a physical row number after realignment of modified row, wherein
the generating differential data includes determining the physical number of updated row based on the conversion data.

6. The computer-readable recording medium according to claim 5, further causing the computer to execute deleting, when a row in the first table has been deleted, a physical number of deleted row from the conversion data.

7. The computer-readable recording medium according to claim 5, wherein the generating differential data includes outputting to the differential data, upon a row getting added to the first table and provided that the conversion table includes data that maintains as the physical row number before realignment of the physical row number of the added row, data to the effect that the physical row number before realignment in the data be modified to the physical row number after realignment in the second database, and deletes the data from the conversion table.

8. A computer-readable recording medium that stores therein a computer program that for reflecting data for replicating a first table in a first database to a second table in a second database, the computer program causing the computer to execute:
generating, when the data being initial data for newly generating the second table, the second table by including an additional column in to columns of the first table included in the first database, for setting a physical row number of each row in the table, and sets in the column of a row wherein the data is added, the physical row number that is recorded in the data and corresponds to data that indicates a content of the row; and
reflecting, when the data being differential data for updating the second table, by checking with the additional column, the physical row number that is recorded in the data and corresponds to data that indicates updation content, and identifying the row that is subjected to updation.

9. A database device that replicates a first table included in the database device as a second table in another database device, the database device comprising:
an initial data generating unit that generates initial data that includes a correspondence of content of each row of the first table and a physical row number of the row; and
a differential data generating unit that generates differential data, when contents of a row in the first table have been updated, that includes a correspondence of changes in the row and a physical row number of updated row.

10. A database device that replicates a second table in the database device by fetching predetermined data relating to a first table included in another database device, the database device comprising:
an initial data reflecting unit that generates, when the data being initial data for newly generating the second table, the second table by including an additional column in to columns of the first table included in the first database, for setting a physical row number of each row in the table, and sets in the column of a row wherein the data is added, the physical row number that is recorded in the data and corresponds to data that indicates a content of the row; and
a differential data reflecting unit that carries out an updation process, when the data being differential data for updating the second table, by checking with the additional column, the physical row number that is recorded in the data and corresponds to data that indicates updation content, and identifying the row that is subjected to updation.
